(19) United States
(12) Patent Application Publication
(10) Pub. No.: US 2026/0252084 A1
(43) Pub. Date: Aug. 27, 2026

(54) SYSTEM AND APPARATUS SUITABLE FOR FACILITATING CART TRANSPORTATION, AND A PROCESSING METHOD IN ASSOCIATION THERETO

(71) Applicant: AUMOVIO Germany GmbH, Frankfurt am Main (DE)

(72) Inventor: Michael Colin Hoy, Singapore (SG)

(73) Assignee: AUMOVIO Germany GmbH, Frankfurt am Main (DE)

(21) Appl. No.: 19/159,213

(22) PCT Filed: Feb. 15, 2024
(86) PCT No.: PCT/EP2024/053792

§ 371 Date: Aug. 22, 2025

(30) Foreign Application Priority Data
Feb. 22, 2023 (GB) 2302487.0

(51) Int. Cl. G05D 1/24; G05D 1/661; G05D 1/667; G05D 101/15; G05D 105/20; G05D 109/10; G05D 111/10

(52) U.S. Cl. CPC G05D 1/24; G05D 1/661; G05D 1/667; G05D 2101/15; G05D 2105/20; G05D 2109/10; G05D 2111/17

(57) ABSTRACT

There is provided a processing method suitable for facilitating cart transportation, which may include an initialization step wherein a state estimate in association with a cart state associated with a cart is determined. The cart comprises a cart body and a plurality of wheels coupled to the cart body. An inference step of the method wherein an overall state update associable with the cart is inferable, the overall state update being associated with a cost function. The cost function can include a longitudinal position error parameter with respect to the cart body, a lateral positional error parameter between the cart body corners where observable, and positioning parameter corresponding to positioning of the wheels with respect to state estimate.

### TECHNICAL FIELD

The present disclosure generally relates to a system and an apparatus suitable for facilitating cart transportation. The present disclosure further relates a processing method which can be thereto.

### BACKGROUND

Automated guided vehicles (AGVs) can be useful for cart detection and subsequent cart pick-up. For example, an AGV can primarily be used for picking up one or more carts and move the carts to one or more other desired locations (i.e., cart transportation).

AGV's are normally outfitted with one or more sensors to facilitate detection. Moreover, carts can mostly be associated with a fixed shape/size such that a fixed template matching approach can possibly be utilized (e.g., see Bostelman, Roger, Roger Bostelman, and Tsai Hong. Review of Research for Docking Automatic Guided Vehicles and Mobile Robots. US Department of Commerce, National Institute of Standards and Technology, 2016.).

In this regard, it is appreciable that the fixed template matching approach is an example of a conventional technique for detecting cart(s) to facilitate cart transportation.

### SUMMARY

In accordance with an aspect of the disclosure, there is provided a processing method which can, for example, be suitable for facilitating cart transportation. In one embodiment, the processing method can, for example, include an initialization step and an inference step. In another embodiment, the processing method can, for example, further include a preprocessing step.

With regard to the initialization step, a state estimate in association with a cart state can be determined. The cart state can be associated with a cart. The cart can, for example, include a cart body and a plurality of wheels. The plurality of wheels can be coupled to the cart body. Generally, the wheels can, for example, be configured to facilitate movement of the cart body.

With regard to the inference step, an overall state update associable with the cart can be inferred. The overall state update can be associated with a cost function. The cost function can, for example, include a longitudinal position error parameter with respect to the cart body, a lateral positional error parameter between the cart body corners where observable, and positioning parameter corresponding to positioning of the wheels with respect to state estimate.

With regard to the preprocessing step, positions of the wheels and/or orientations of the wheels can, for example, be determined based on captured data.

Accordingly, the present disclosure contemplates a sensor fusion approach which can, for example, be based on a combination of detection of cart wheel(s) and detection of cart body, in accordance with an embodiment of the disclosure. This can, for example, be helpful for cart docking (e.g., referable to as “cart pick-up”) in relation with carts having castor wheels. In accordance with an embodiment of the disclosure, it is contemplated that, in one example, for a cart with castor wheels (which may be associated with arbitrary rotation around a vertical axis), ambiguity may possibly be introduced when regressing cart pose from detection of the (castor) wheel(s).

In the above manner, it is contemplated that at least a robust way (e.g., which addresses the aforementioned ambiguity) and/or efficient way (e.g., which mitigates the necessity of pick-up/detection aids) for cart detection and/or pick-up can be provided/facilitated, in accordance with an embodiment of the disclosure.

The present disclosure further contemplates a computer program which can include instructions which, when the program is executed by a computer, cause the computer to carry out the initializing step, the preprocessing step and/or the inference step as discussed with reference to the processing method.

The present disclosure yet further contemplates a computer readable storage medium (not shown) having data stored therein representing software executable by a computer, the software including instructions, when executed by the computer, to carry out the initializing step, the preprocessing step and/or the inference step as discussed with reference to the processing method.

The above-described aspect(s) of the processing method of the present disclosure can also apply analogously (all) the aspect(s) of a below described apparatus of the present disclosure. Likewise, all below described aspect(s) of the apparatus of the disclosure can also apply analogously (all) the aspect(s) of above described processing method of the disclosure.

In accordance with an aspect of the disclosure, there is provided an apparatus which can, for example, be suitable for facilitating cart transportation. The apparatus can, for example, be associated with the processing method, in accordance with an embodiment of the disclosure.

The apparatus can, for example, include a first module, a second module and a third module, in accordance with an embodiment of the disclosure.

In one embodiment, the first module (e.g., corresponding to a receiver) can, for example, be configured to receive at least one input signal. The second module (e.g., corresponding to a processor) can, for example, be configured to process the input signal(s) according to the processing method as discussed above to generate at least one output signal. The third module (e.g., corresponding to a transmitter) can, for example, be configured to communicate the output signal(s). The output signal(s) can, for example, to communicable to a robot (e.g., a AGV) and/or one or more device(s) 104. The output signal(s) can, for example, be used for facilitating cart transportation (e.g., cart detection and/or cart pick-up).

Accordingly, the present disclosure contemplates a sensor fusion approach which can, for example, be based on a combination of detection of cart wheel(s) and detection of cart body, in accordance with an embodiment of the disclosure. This can, for example, be helpful for cart docking (e.g., referable to as “cart pick-up”) in relation with carts having castor wheels. In accordance with an embodiment of the disclosure, it is contemplated that, in one example, for a cart with castor wheels (which may be associated with arbitrary rotation around a vertical axis), ambiguity may possibly be introduced when regressing cart pose from detection of the (castor) wheel(s).

In the above manner, it is contemplated that at least a robust way (e.g., which addresses the aforementioned ambiguity) and/or efficient way (e.g., which mitigates the necessity of pick-up/detection aids) for cart detection and/or pick-up can be provided/facilitated, in accordance with an embodiment of the disclosure.

### BRIEF DESCRIPTION OF THE DRAWINGS

Embodiments of the disclosure are described hereinafter with reference to the following drawings, in which:

FIG. 1 shows a system which can include at least one apparatus, according to an embodiment of the disclosure;

FIG. 2 shows the apparatus of FIG. 1 in further detail, according to an embodiment of the disclosure; and

FIG. 3 shows a processing method in association with the system of FIG. 1, according to an embodiment of the disclosure.

### DETAILED DESCRIPTION

The present disclosure contemplates that cart transportation can be associated with/include one or both of cart detection and cart pick-up (i.e., cart detection and/or cart pick-up).

An Automated guided vehicle (AGV) can, for example, carry a plurality of sensors to facilitate detection (e.g., cart detection). The sensors can, for example, include one or more light detection and ranging (lidar) sensors and/or one or more depth sensor(s). An example of a lidar sensor can be a 2D (2 dimension)-based lidar camera and an example of a depth sensor can be a depth camera. In one specific example, an AGV can carry at least one 2D lidar camera and at least one depth camera, in accordance with an embodiment of the disclosure.

Based on cart detection, the AGV can be configured to perform one or more tasks in relation to cart pick-up of one or more carts. Subsequent to cart pick-up, the AGV can be configured to move (i.e., transport) the cart(s) from one location to another (desired) location. Cart pick-up (e.g., referable to as “cart docking”) can, for example, be based on an initial approach phase (e.g., when the AGV is initially approaching a general location of where a cart is parked) and a final alignment phase (e.g., after the initial approach phase where the AGV is performing a task of fine positional adjustment with respect to the cart so as to dock the cart onto the AGV), in accordance with an embodiment of the disclosure.

The present disclosure contemplates that in certain situations information related to a precise 3D model of a cart may not be available in advance. It is further contemplated that it may be useful to facilitate cart pickup without the need for pick-up/detection aids (e.g., retrofitting one or more alignment markers, retrofitting special lockable wheels and/or providing cart docking stations). It is contemplated that pick-up/detection aids (e.g., retrofitting) may add to deployment cost(s). Moreover, it is contemplated that for a cart with castor wheels (which may be associated with arbitrary rotation around a vertical axis), ambiguity may possibly be introduced when regressing cart pose from detection of the (castor) wheel(s).

Accordingly, the present disclosure contemplates a sensor fusion approach which can, for example, be based on a combination of detection of cart wheel(s) and detection of cart body, in accordance with an embodiment of the disclosure. This can, for example, be helpful for cart docking (e.g., referable to as “cart pick-up”) in relation with carts having castor wheels.

In the above manner, it is contemplated that at least a robust way (e.g., which addresses the aforementioned ambiguity) and/or efficient way (e.g., which mitigates the necessity of pick-up/detection aids) for cart detection and/or pick-up can be provided/facilitated, in accordance with an embodiment of the disclosure.

The foregoing will be discussed in further detail with reference to FIG. 1 to FIG. 3 hereinafter.

Referring to FIG. 1, a system 100 is shown, according to an embodiment of the disclosure. The system 100 can, for example, be suitable for facilitating cart transportation (e.g., associable with cart detection and/or cart pick-up), in accordance with an embodiment of the disclosure.

As shown, the system 100 can include one or more apparatuses 102, at least one device 104 and, optionally, a communication network 106, in accordance with an embodiment of the disclosure.

The apparatus(es) 102 can be coupled to the device(s) 104. Specifically, the apparatus(es) 102 can, for example, be coupled to the device(s) 104 via the communication network 106c, in accordance with an embodiment of the disclosure.

In one embodiment, the apparatus(es) 102 can be coupled to the communication network 106 and the device(s) 104 can be coupled to the communication network 106. Coupling can be by manner of one or both of wired coupling and wireless coupling. The apparatus(es) 102 can, in general, be configured to communicate with the device(s) 104 via the communication network 106, according to an embodiment of the disclosure.

Generally, in accordance with an embodiment of the disclosure, the apparatus(es) 102 can be configured to receive one or more input signals and process the input signal(s) to generate/derive one or more output signals. Moreover, in accordance with an embodiment of the disclosure, the device(s) 104 can, for example, be configured to one or both of generate the input signal(s) and communicate the input signal(s) to the apparatus(es) 102.

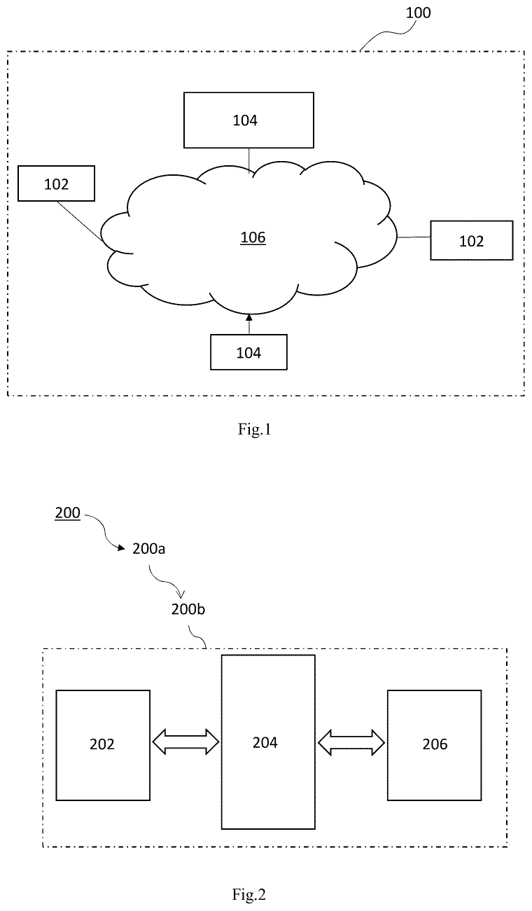

The apparatus(es) 102 can, for example, be configured to process the input signal(s) to generate/derive the output signal(s), in accordance with an embodiment of the disclosure. In one embodiment, the apparatus(es) 102 can, for example, be carried by an AGV. In another embodiment, the apparatus(es) 102 can, for example, be remote with respect to an AGV (e.g., be in remote communication with an AGV and not carried by the AGV). In yet another embodiment, a portion of the apparatus(es) 102 can, for example, be carried by an AGV and another portion of the apparatus(es) 102 can, for example, be remote with respect to the AGV. The apparatus(es) 102 will be discussed in further detail with reference to FIG. 2, in accordance with an embodiment of the disclosure

The device(s) 104 can, for example, be configured to generate the input signal(s) and/or communicate the input signal(s), in accordance with an embodiment of the disclosure. For example, the input signal(s) can be communicated from the device(s) 104 to the apparatus(es) 102. In one example, a device 104 can be associated with/correspond to/include one or more sensors (e.g., a 2D lidar camera and/or a depth camera). In one embodiment, the device(s) 104 can, for example, be carried by an AGV. In another embodiment, the device(s) 104 can, for example, be remote with respect to an AGV (e.g., be in remote communication with an AGV and not carried by the AGV). In yet another embodiment, a portion of the device(s) 104 can, for example, be carried by an AGV and another portion of the device(s) 104 can, for example, be remote with respect to the AGV.

The communication network 106 can, for example, correspond to an Internet communication network, a wired-based communication network, a wireless-based communication network, or any combination thereof. Communication (i.e., between the apparatus(es) 102 and the device(s) 104) via the communication network 106 can be by manner of one or both of wired communication and wireless communication.

In one general example, the input signal(s) (e.g., which can include 2D lidar data and/or depth camera data) can be communicated from the device(s) 104 and received by the apparatus(es) 102 for processing to generate one or more output signals which can be communicated from the apparatus(es) 104. The output signal(s) can, for example, correspond to control signal(s) which can, for example, be used for navigation of an AGV for facilitating cart transportation (e.g., which can be associated with cart detection and/or cart pick-up), in accordance with an embodiment of the disclosure.

The aforementioned apparatus(es) 102 will be discussed in further detail with reference to FIG. 2 hereinafter.

Referring to FIG. 2, an apparatus 102 is shown in further detail in the context of an example implementation 200, according to an embodiment of the disclosure.

In the example implementation 200, the apparatus 102 can correspond to an electronic module 200a which can, for example, be capable of performing one or more processing tasks, in accordance with an embodiment of the disclosure.

The electronic module 200a can, for example, include a casing 200b. Moreover, the electronic module 200a can, for example, carry any one of a first module 202, a second module 204, a third module 206, or any combination thereof.

In one embodiment, the electronic module 200a can carry a first module 202, a second module 204 and/or a third module 206. In a specific example, the electronic module 200a can carry a first module 202, a second module 204 and a third module 206, in accordance with an embodiment of the disclosure.

In this regard, it is appreciable that, in one embodiment, the casing 200b can be shaped and dimensioned to carry any one of the first module 202, the second module 204 and the third module 206, or any combination thereof.

The first module 202 can be coupled to one or both of the second module 204 and the third module 206. The second module 204 can be coupled to one or both of the first module 202 and the third module 206. The third module 206 can be coupled to one or both of the first module 202 and the second module 204. In one example, the first module 202 can be coupled to the second module 204 and the second module 204 can be coupled to the third module 206, in accordance with an embodiment of the disclosure. Coupling between the first module 202, the second module 204 and/or the third module 206 can, for example, be by manner of one or both of wired coupling and wireless coupling. Each of the first module 202, the second module 204 and the third module 206 can correspond to one or both of a hardware-based module and a software-based module, according to an embodiment of the disclosure.

In one example, the first module 202 can correspond to a hardware-based receiver which can be configured to receive one or more input signals.

The second module 204 can, for example, correspond to a network-based/software-based and/or hardware-based (e.g., a microprocessor) processing module which can be configured to perform one or more processing tasks in association with any one of, or any combination of, the following:
Initialization
Pre-processing
Inference-based processing

Specifically, the second module 204 can, for example, be configured to process the received input signal(s) by manner of initialization, preprocessing and/or inference-based processing in a manner so as to generate/derive one or more output signal(s), in accordance with an embodiment of the disclosure.

The third module 206 can, in one example, correspond to a hardware-based transmitter which can be configured to communicate the output signal(s) from the electronic module 200a, in accordance with an embodiment of the disclosure. The output signal(s) can, for example, be communicated from the electronic module 200a to one or more devices 104 and/or one or more other apparatuses 102, in accordance with an embodiment of the disclosure.

The present disclosure contemplates the possibility that the first and second modules 202/204 can be an integrated software-hardware based module (e.g., an electronic part which can carry a software program/algorithm in association with receiving and processing functions/an electronic module programmed to perform the functions of receiving and processing). The present disclosure further contemplates the possibility that the first and third modules 202/206 can be an integrated software-hardware based module (e.g., an electronic part which can carry a software program/algorithm in association with receiving and transmitting functions/an electronic module programmed to perform the functions of receiving and transmitting). The present disclosure yet further contemplates the possibility that the first and third modules 202/206 can be an integrated hardware module (e.g., a hardware-based transceiver) capable of performing the functions of receiving and transmitting.

The above example implementation 200 will now be discussed in further detail with reference to an example scenario, in accordance with an embodiment of the disclosure hereinafter.

In the example scenario, the second module 204 can, for example, correspond to a processor capable of processing (i.e., perform one or more processing tasks) the received input signal(s), at each time instant, by manner of initialization, preprocessing and/or inference-based processing to generate one or more output signals, in accordance with an embodiment of the disclosure.

The forementioned initialization, preprocessing and inference-based processing will be discussed in turn, in accordance with an embodiment of the disclosure, hereinafter.

In regard to initialization, the second module 204 can be configured to initialize a default state estimate in association with at least one cart (e.g., a cart state associated with a cart). The default state estimate (simply referable to as “state estimate”) of the cart state can, for example, include one or more parameters such as any one of cart body position, cart size/shape, wheel size and caster offset, detectable element topology, position/rotation angle, or any combination thereof. In one example, state estimate of the cart state can include parameters such as cart body position, cart size/shape, wheel size and caster offset, detectable element topology and position/rotation angle, in accordance with an embodiment of the disclosure. In another example, the state estimate of the cart state can further include one or more other parameters which can be indicative of positions of the wheels, in accordance with an embodiment of the disclosure.

In one embodiment, cart body position can be assumed to define the center of a coordinate system, cart size/shape can be based on dimensions (e.g., width of the cart body, length of the cart body, longitudinal wheel offset and/or lateral wheel offset) associated with a cart (e.g., state_width, state_length, state_longitudinal_wheel_offset, state_lateral_wheel_offset). Moreover, wheel size and caster offset can be based on dimensions (e.g., width of the wheel(s), radius of the wheel(s) and/or caster offset) associated with the wheel(s) of the cart (e.g., state_wheel_width, state_wheel_radius, state_castor_offset). Additionally, detectable element topology can be based on any one of a condition that all castor wheels can be observed, a condition that the regions associated with the castor wheels can be observed (i.e., each castor wheel can be associated with a region such as a rectangular region within which the castor wheel can reside), a condition that at least 2 regions associated with 4 castor wheels can be observed (e.g., two rectangular regions wherein a pair of wheels can reside in each rectangular region), or any combination thereof. Furthermore, position/rotation angle can be based on position/rotation angle associated with an AGV (e.g., referable to as a “robot”), and such position (e.g., position in “X” coordinate and position in “Y” coordinate)/rotation angle can be assumed to be capable of being expressed as a trajectory initialized by the odometry data (state_robot_x, state_robot_y, state_robot_rotation_angle). In this regard, it is appreciable that the aforementioned input signal(s) can, for example, include odometry data communicable from one or more motion sensors (e.g., the aforementioned device(s) 104 can, for example, include one or more motion sensors, in accordance with an embodiment of the disclosure) carried by the robot).

It is contemplated that, for example, the castor wheel(s) and/or the rectangular region(s) can be referred to as “posts”, in accordance with an embodiment of the disclosure. It is further contemplated that, for example, a template can include the following information/data:
A) Size of the body (upper/lower bound)
B) List of post groups, wherein each post group can, for example, include:
   I) Post type (castor wheel or rectangular post)
      CastorWheel:
         wheel_offset_to_wheel_circumfrence_ratio (upper/lower bound)
         wheel_width_to_wheel_circumfrence_ratio (upper/lower bound)
         wheel_circumfrence (upper/lower bound)
      Rectangle:
         post_length (upper/lower bound)
         post_width (upper/lower bound)
   II) Position relative to the edge of the cart (upper/lower bounds on xy coordinates)
   III) Symmetry type (Single post, left right symmetry, front back symmetry, or four way symmetry)

It is yet further contemplated that, for example, multiple templates can be configured for each deployment, each template can be assessed to determine one associated with best-matching data, in accordance with an embodiment of the disclosure.

In regard to preprocessing, one or both of: Data concerning wheel position(s) and/or wheel orientation(s) can be determined and Depth data can be processed For example, the input signal(s) can include one or both of data communicable from the lidar sensor(s) (e.g., 2D lidar data) and data communicable from the depth sensor(s) (e.g., depth camera data), in accordance with an embodiment of the disclosure.

In one specific example, 2D lidar data can be received and processed to determine the wheel position(s) and/or orientation(s). Processing can, for example, be based on any one of clustering-based processing (e.g., jump distance clustering or divide cart region into quadrants), wheel fitting-based processing (e.g., Random sample consensus, RANSAC, processing, non-linear least squares processing, and/or training a neural network to regress the wheel pose from a subset of the 2D lidar data), occlusion characterization-based processing (e.g., determining which side(s) of the fitted wheel is/are potentially occluded), or any combination thereof. For example, 2D lidar data can be processed by manner of clustering-based processing, wheel fitting-based processing and occlusion characterization-based processing to determine wheel position(s) and/or orientation(s), in accordance with an embodiment of the disclosure.

In one embodiment, regarding occlusion characterization-based processing, it is contemplated that the lidar points adjacent to the wheels can be utilized to determine whether a point is closer (i.e., indicative of occlusion) or further away (i.e., indicative of non-occlusion). For the nearest detected corner of a wheel, it can be assumed that one or more following parameters associated with a wheel can be determined/detected:
detected_wheel_x_corner,
detected_wheel_y_corner,
detected_wheel_rotation_angle,
detected_wheel_observed_width,
detected_wheel_observed_length,
has_lateral_occlusion,
has_longitudinal_occlusion

Moreover, it can be assumed that, for example, double occlusion of a wheel is not possible, in accordance with an embodiment of the disclosure.

In one specific example, depth camera data which can include depth data can be received and processed. For example, RANSAC template fitting can be utilized and/or a neural network receives and processed data in the bird's eye view (BEV frame) to output either a direct shape estimate or a segmented bitmap image can be utilized, in accordance with an embodiment of the disclosure. It can, for example, be assumed that the nearest vertical face of a cart can be characterized based on, for example, determination of the position of the two nearest corners:
has left_side_observable
detected_body_x_left
detected_body_y_left
has_right_side_observable
detected_body_x_right
detected_body_y_right

In regard to inference-based processing, it is contemplated that one or more statistical inference approach-based technique(s) (e.g. sliding window factor graph nonlinear Bayesian filter such as extended Kalman filter, unscented Kalman filter, particle filter etc. and variational bayes Kalman filter) can possibly be utilized to infer an overall state update which can be associated with a cost function, in accordance with an embodiment of the disclosure. The cost function can, for example, include any one of, or any combination of, the following parameter(s):
longitudinal position error with respect to a cart body
lateral positional error between the corners of the cart body, where observable
position of the wheel(s) with respect to that expected according to the state estimate

It is contemplated that, in one embodiment, if sliding window factor graph is utilized, one or more keyframes can be strategically selected where some keyframes from the initial approach (e.g., when the robot is initially approaching a cart) can be selected even when the final alignment (e.g., after the initial approach where the robot is undergoing fine positional adjustment with respect to the cart so as to dock the cart) is underway.

Generally, in accordance with an embodiment of the disclosure, the input signal(s) (e.g., which can include odometry data, 2D lidar data and/or depth camera data) can be received (e.g., by the first module 202) and processed (e.g., by the second module 204) by manner of, for example, initialization, preprocessing and/or inference-based processing to generate one or more output signals which can be communicated (e.g., via the third module 206). The output signal(s) can, for example, correspond to control signal(s) which can, for example, be used for navigation of an AGV for facilitating cart transportation (e.g., which can be associated with cart detection and/or cart pick-up), in accordance with an embodiment of the disclosure.

Accordingly, the present disclosure contemplates a sensor fusion approach which can, for example, be based on a combination of detection of cart wheel(s) and detection of cart body, in accordance with an embodiment of the disclosure. This can, for example, be helpful for cart docking (e.g., referable to as “cart pick-up”) in relation with carts having castor wheels. In accordance with an embodiment of the disclosure, it is contemplated that, in one example, for a cart with castor wheels (which may be associated with arbitrary rotation around a vertical axis), ambiguity may possibly be introduced when regressing cart pose from detection of the (castor) wheel(s).

In the above manner, it is contemplated that at least a robust way (e.g., which addresses the aforementioned ambiguity) and/or efficient way (e.g., which mitigates the necessity of pick-up/detection aids) for cart detection and/or pick-up can be provided/facilitated, in accordance with an embodiment of the disclosure.

The above-described aspect(s) of the apparatus 102 of the present disclosure can also apply analogously (all) the aspect(s) of a below described processing method of the present disclosure. Likewise, all below described aspect(s) of the processing method of the disclosure can also apply analogously (all) the aspect(s) of above described apparatus 102 of the disclosure. It is to be appreciated that these remarks apply analogously to the earlier discussed system 100 of the present disclosure.

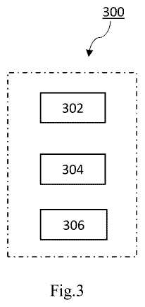

Referring to FIG. 3, a processing method in association with the system 100 is shown, according to an embodiment of the disclosure. The processing method 300 can, for example, be suitable for facilitating cart transportation, in accordance with an embodiment of the disclosure. Moreover, the processing method 300, or any portion/part thereof, can, for example, possibly be performed at each time instant, in accordance with an embodiment of the disclosure.

The processing method 300 can, for example, include any one of an initializing step 302, a preprocessing step 304 and an inference step 306, or any combination thereof, in accordance with an embodiment of the disclosure.

In one embodiment, the processing method 300 can include an initializing step 302, a preprocessing step 304 and an inference step 306. In another embodiment, the processing method 300 can include an initializing step 302 and a preprocessing step 304. In yet another embodiment, the processing method 300 can include a preprocessing step 304 and an inference step 306. In yet a further embodiment, the processing method 300 can include an inference step 306. In yet a further additional embodiment, the processing method 300 can include one of an initializing step 302, a preprocessing step 304 and an inference step 306 (i.e., an initializing step 302, a preprocessing step 304 or an inference step 306). In yet another further additional embodiment, the processing method 300 can, for example, include an initialization step 302 and an inference step 306.

With regard to the initializing step 302, one or more processing tasks in association with initializing a default state estimate (referable to as “state estimate”) in association with at least one cart can be performed, in accordance with an embodiment of the disclosure. For example, the apparatus(es) 102 can be configured to perform the processing task(s) in association with the initialization of a state estimate in association with a cart (e.g., a state estimate of a cart state associated with a cart), as discussed earlier with reference to FIG. 2, in accordance with an embodiment of the disclosure.

With regard to the preprocessing step 304, one or more processing tasks in association with one or both of: determination of data concerning wheel position(s) and/or wheel orientation(s) can be determined, and processing of depth data can be performed, in accordance with an embodiment of the disclosure.

For example, in accordance with an embodiment of the disclosure, the apparatus(es) 102, as discussed earlier with reference to FIG. 2, can be configured to perform the processing task(s) in association with one or both of: determination of data concerning wheel position(s) and/or wheel orientation(s) and processing of depth data

With regard to the inference step 306, one or more processing tasks in association with inference-based processing can be performed, in accordance with an embodiment of the disclosure. For example, inference-based processing can be associated with an inference of an overall state update. As mentioned earlier, an overall state update can, for example, be associated with a cost function. For example, the apparatus(es) 102 can be configured to perform the processing task(s) in association with the inference-based processing, as discussed earlier with reference to FIG. 2, in accordance with an embodiment of the disclosure.

It is appreciable that the steps (e.g., initializing step 302, preprocessing step 304 and/or inference step 306) need not be sequential steps per se. For example, multiple templates can be fit simultaneously to determine the best template in cases where there is insufficient data available at initialization to distinguish a template, in accordance with an embodiment of the disclosure.

The present disclosure further contemplates a computer program (not shown) which can include instructions which, when the program is executed by a computer (not shown), cause the computer to carry out the initializing step 302, the preprocessing step 304 and/or the inference step 306 as discussed with reference to the processing method 300.

The present disclosure yet further contemplates a computer readable storage medium (not shown) having data stored therein representing software executable by a computer (not shown), the software including instructions, when executed by the computer, to carry out the initializing step 302, the preprocessing step 304 and/or the inference step 306 as discussed with reference to the processing method 300.

In view of the foregoing, it is appreciable that the present disclosure generally contemplates a processing method 300 which can, for example, be suitable for facilitating cart transportation. In one embodiment, the processing method 300 can, for example, include an initialization step 302 and an inference step 306.

With regard to the initialization step 302, a state estimate in association with a cart state can be determined. The cart state can be associated with a cart. The cart can, for example, include a cart body and a plurality of wheels. The plurality of wheels can be coupled to the cart body. Generally, the wheels can, for example, be configured to facilitate movement of the cart body.

With regard to the inference step 306, an overall state update associable with the cart can be inferred. The overall state update can be associated with a cost function. The cost function can, for example, include a longitudinal position error parameter with respect to the cart body, a lateral positional error parameter between the cart body corners where observable, and positioning parameter corresponding to positioning of the wheels with respect to state estimate.

In one embodiment, the processing method 300 can, for example, further include a preprocessing step 304. With regard to the preprocessing step 304, positions of the wheels and/or orientations of the wheels can, for example, be determined based on captured data. Captured data can, for example, be communicated from the device(s) 104, in accordance with an embodiment of the disclosure. The device(s) 104 can, for example, include one or more sensors. The sensor(s) can, for example, include one or both of at least one lidar sensor (e.g., 2D lidar sensor) and at least one depth sensor (e.g., depth camera). For example, captured data can include lidar data (e.g., 2D lidar data) and/or depth data (e.g., camera depth data). In one specific example, captured data can be communicated from at least one lidar sensor and/or at least one depth sensor.

In one embodiment, captured data can be processed by manner of any one of clustering-based processing, wheel fitting-based processing and occlusion characterization-based processing, or any combination thereof (i.e., at least one of clustering-based processing, wheel fitting-based processing and occlusion characterization-based processing; clustering-based processing, wheel fitting-based processing and/or occlusion characterization-based processing). In one example, clustering-based processing can be based on jump distance clustering or division of cart region into quadrants. In one example, wheel fitting-based processing can be based on one or both of Random sample consensus (RANSAC) processing non-linear least squares processing and training a neural network to regress wheel pose from a subset of the captured data (i.e., at least one of RANSAC and training a neural network; RANSAC and/or training a neural network). In one example, occlusion characterization-based processing can correspond to determining potential occlusion of any of the wheels.

In one embodiment, the inference step 306 can, for example, include performing at least one processing task in association with inference-based processing. Inference-based processing can, for example, be associated with at least one statistical inference approach-based technique. A statistical inference approach-based technique can, for example, be based on any one of sliding window factor graph and variational bayes Kalman filter (i.e., sliding window factor graph or variational bayes Kalman filter). In one example, wherein where sliding window factor graph is utilized, a plurality of keyframes can be strategically selected where some keyframes from an initial approach are selected even when final alignment is underway.

Further, in view of the foregoing, it is appreciable that the present disclosure further generally contemplates an apparatus 102 in association with the processing method 300, in accordance with an embodiment of the disclosure. The apparatus 102 can, for example, be suitable for facilitating cart transportation. Moreover, the apparatus 102 can, for example, correspond to an electronic module 200a as discussed earlier with reference to FIG. 2, in accordance with an embodiment of the disclosure.

The apparatus 102 can, for example, include a first module 202, a second module 204 and a third module 206, in accordance with an embodiment of the disclosure.

In one embodiment, the first module 202 (e.g., corresponding to a receiver) can, for example, be configured to receive at least one input signal (e.g., communicable from at least one device 104). The second module 204 (e.g., corresponding to a processor) can, for example, be configured to process the input signal(s) according to the processing method 300 as discussed above to generate at least one output signal. The third module 206 (e.g., corresponding to a transmitter) can, for example, be configured to communicate the output signal(s). The output signal(s) can, for example, to communicable to a robot (e.g., a AGV) and/or one or more device(s) 104. The output signal(s) can, for example, be used for facilitating cart transportation (e.g., cart detection and/or cart pick-up).

Accordingly, the present disclosure contemplates a sensor fusion approach which can, for example, be based on a combination of detection of cart wheel(s) and detection of cart body, in accordance with an embodiment of the disclosure. This can, for example, be helpful for cart docking (e.g., referable to as “cart pick-up”) in relation with carts having castor wheels. In accordance with an embodiment of the disclosure, it is contemplated that, in one example, for a cart with castor wheels (which may be associated with arbitrary rotation around a vertical axis), ambiguity may possibly be introduced when regressing cart pose from detection of the (castor) wheel(s).

In the above manner, it is contemplated that at least a robust way (e.g., which addresses the aforementioned ambiguity) and/or efficient way (e.g., which mitigates the necessity of pick-up/detection aids) for cart detection and/or pick-up can be provided/facilitated, in accordance with an embodiment of the disclosure.

It should be appreciated that the embodiments described above can be combined in any manner as.

It should be further appreciated by the person skilled in the art that variations and combinations of embodiments described above, not being alternatives or substitutes, may be combined to form yet further embodiments.

In one example, the communication network 106 can be omitted.

Communication (i.e., between the apparatus(es) 102 and the device(s) 104) can be by manner of direct coupling. Such direct coupling can be by manner of one or both of wired coupling and wireless coupling. For example, the apparatus(es) 102 and the device(s) 104 can be carried by an AGV, and the apparatus(es) 102 and the device(s) 104 can be directly coupled, in accordance with an embodiment of the disclosure.

In another example, estimates of the cart wheel rotation angles can possibly be utilized to determine if a cart has been disturbed so that the robot can abort the docking maneuver (i.e., final alignment), depart from the cart and retry the initial approach.

In the foregoing manner, various embodiments of the disclosure are intended to be encompassed by the following claims, and are not to be limited to specific forms or arrangements of parts so described and it will be apparent to one skilled in the art in view of this disclosure that numerous changes and/or modification can be made, which are also intended to be encompassed by the following claims.

1. A processing method (300) suitable for facilitating cart transportation, the processing method (300) comprising:
an initialization step (302) wherein a state estimate in association with a cart state associated with a cart is determined, the cart comprising a cart body and a plurality of wheels coupled to the cart body, and
an inference step (306) wherein an overall state update associable with the cart is inferable, the overall state update being associated with a cost function,
wherein the cost function comprises:
a longitudinal position error parameter with respect to the cart body,
a lateral positional error parameter between the cart body corners where observable, and
positioning parameter corresponding to positioning of the wheels with respect to state estimate.

2. The processing method (300) of claim 1, further comprising a preprocessing step (304), one or both of positions of the wheels and orientations of the wheels being determined based on captured data.

3. The processing method (300) of any of the preceding claims, further comprising a preprocessing step (304), depth data being determined based on captured data.

4. The processing method (300) of any of the preceding claims, captured data being communicable from one or both of at least one light detection and ranging (lidar) sensor and at least one depth sensor.

5. The processing method (300) of any of the preceding claims, captured data being processed by manner of at least one of clustering-based processing, wheel fitting-based processing and occlusion characterization-based processing.

6. The processing method (300) of any of the preceding claims, clustering-based processing being based on any one of jump distance clustering and division of cart region into quadrants.

7. The processing method (300) of any of the preceding claims, wheel fitting-based processing being based on at least one of Random sample consensus (RANSAC) processing non-linear least squares processing and training a neural network to regress wheel pose from a subset of the captured data.

8. The processing method (300) of any of the preceding claims, occlusion characterization-based processing corresponding to determining potential occlusion of any of the wheels.

9. The processing method (300) of any of the preceding claims, wherein the inference step (306) includes performing at least one processing task in association with inference-based processing.

10. The processing method (300) of any of the preceding claims, wherein inference-based processing is associated with at least one statistical inference approach-based technique.

11. The processing method (300) of any of the preceding claims wherein a statistical inference approach-based technique is based on any one of sliding window factor graph and variational bayes Kalman filter,

12. The processing method (300) of any of the preceding claims, wherein where sliding window factor graph is utilized, a plurality of keyframes are strategically selected where some keyframes from an initial approach are selected even when final alignment is underway.

13. A computer program comprising instructions which, when the program is executed by a computer, cause the computer to carry out at least one of the initializing step (302), the preprocessing step (304) and the inference step (306) according to the processing method (300) of any of the preceding claims.

14. A computer readable storage medium having data stored therein representing software executable by a computer, the software including instructions, when executed by the computer, to carry out at least one of the initializing step (302), the preprocessing step (304) and the inference step (306) according to the processing method (300) of any of claims 1 to 12.

15. An apparatus (102) comprising:
a first module (202) configurable to receive at least one input signal;
a second module (204) configurable to process the input signal according to the processing method (300) of any one of claims 1 to 12 to generate at least one output signal; and
a third module (206) configurable to communicate at least one output signal usable for facilitating cart transportation.
